(19) United States
(12) Patent Application Publication
(10) Pub. No.: US 2016/0019192 A1
(43) Pub. Date: Jan. 21, 2016

(54) SYSTEM AND METHOD TO EXTRACT STRUCTURED SEMANTIC MODEL FROM DOCUMENT

(71) Applicant: General Electric Company, Schenectady, NY (US)

(72) Inventors: Andrew Walter Crapo, Niskayuna, NY (US); Abha Moitra, Scotia, NY (US)

(21) Appl. No.: 14/336,578

(22) Filed: Jul. 21, 2014

(51) Int. Cl. G06F 17/22; G06F 17/30

(52) U.S. Cl. CPC G06F 17/2247; G06F 17/30011

(57) ABSTRACT

According to some embodiments, a document associated with an artifact may be received, the document being at least partially unstructured. In an unstructured portion of the document, an extraction platform may automatically detect a first characteristic. The extraction platform may also automatically detect a second characteristic in the unstructured portion of the document. Using the first and second characteristics, a structured semantic model representing the artifact may automatically be created.

### BACKGROUND

A semantic model may include information about various items, and relationships between those items, and may be used to represent and understand an artifact, such as a real world entity or device. In many cases, one or more documents about an artifact (e.g., instruction manuals, user guides, repair documents, etc.) may capture knowledge or requirements related to the artifact and may be authored by a subject matter expert who has detailed knowledge of the structure and behavior of the artifact. This knowledge may comprise a mental model for the author, and is often shared to a significant degree with other subject matter experts. Unfortunately, in many cases an explicit and formal model of the structure of the artifact may not exist.

Extracting knowledge about an artifact from unstructured or semi-structured text may be attempted by statistical or other means that do not include an explicit and formal model of the artifact. For example, it may be determined that a certain section of unstructured text includes a certain term or phrase relatively frequently, and as a result, it may be inferred that the section is therefore associated with a particular feature or portion of an artifact. This approach, however, may significantly limit the usefulness of the extracted knowledge as well as the ability of a knowledge management system to correctly capture the scope of applicability of the knowledge. Moreover, manually building a semantic model, such that extracted knowledge may then be aligned as appropriate, can be a labor-intensive, expensive, and error prone process.

It would therefore be desirable to provide systems and methods to create a structured semantic model in an automatic and accurate manner.

### BRIEF DESCRIPTION OF THE DRAWINGS

FIG. 1 is a high-level architecture of a system in accordance with some embodiments.

FIG. 2 illustrates a method that might be performed according to some embodiments.

FIG. 3 illustrates an example of a document and associated structured semantic model according to some embodiments.

FIG. 4 is block diagram of an extraction platform according to some embodiments of the present invention.

FIG. 5 is a tabular portion of a semantic model database according to some embodiments.

FIG. 6 is an example of a display having table of contents characteristics that might be analyzed in accordance with some embodiments.

FIG. 7 is an example of a document having font characteristics that might be received in accordance with some embodiments.

FIG. 8 is an example of a document having text layout characteristics that might be received in accordance with some embodiments.

FIG. 9 is an example of a document having image characteristics that might be received in accordance with some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

As used herein, the phrase “semantic model” may refer to, for example, a structured model that includes information about various items, and relationships between those items, and may be used to represent and understand an artifact. By way of example, the model might include: systems, subsystems, classes and subclasses, sets and subsets, and/or components and subcomponents. Note that any of these models may include further relationships between items (e.g., a sub-subsystem, relationships between sibling items, rules associated with items, etc.). As used herein, the phrase “artifact” may refer to, for example, any real world entity or device. By way of examples only, the artifact might be a physical apparatus (e.g., an airplane or heart monitor), an organization (e.g., a hospital), a business, a financial arrangement (e.g., a swap agreement or tax code), a government, a regulatory system, etc.

In many cases, one or more “documents” about an artifact may capture knowledge or requirements related to the artifact and may be authored by a subject matter expert who has detailed knowledge of the structure and behavior of the artifact. As used herein, the term document may refer to, for example, a web page, a text file, an image of a document, streaming document information, etc. As used herein, a “structured document” associated with an artifact contains explicit, defined, information about the artifact's items and relationships between those items. Moreover, the phrase “partially unstructured document” may refer to either a completely unstructured document or a semi-structured document.

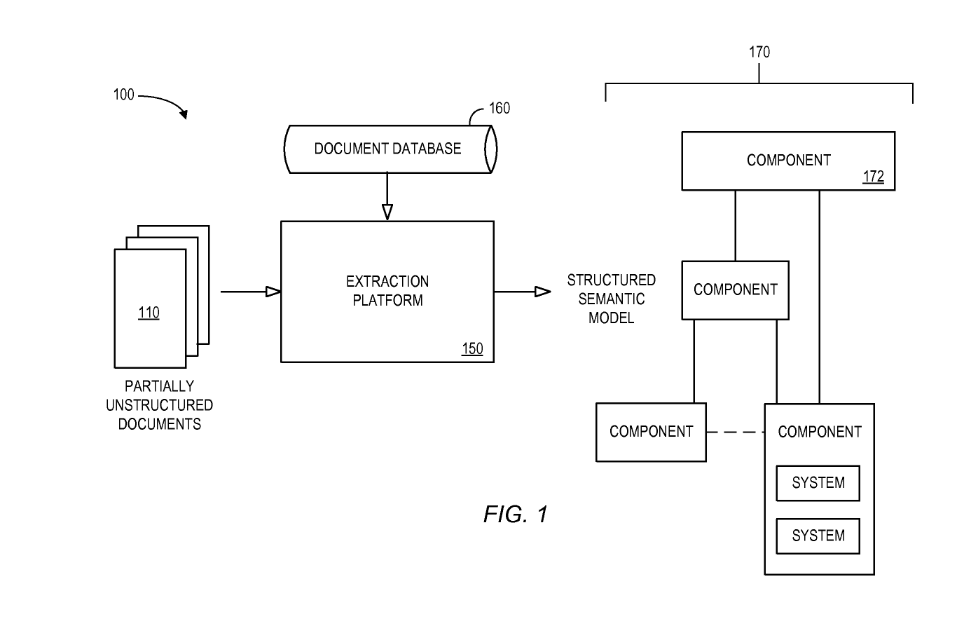

FIG. 1 is a high-level architecture of a system 100 to create a structured semantic model in an automatic and accurate manner according to some embodiments. The system 100 includes one or more partially structured documents 110, associated with an artifact, that may be provided to an extraction platform 150. The extraction platform 150 may also access information in a document database 160 instead of or in addition to receiving the documents 110. The extraction platform 150 may then automatically generate a structured semantic model 170 as appropriate. The semantic model 170 may, for example, define components 172 of the artifact and relationships between components 172. As used herein, the term “automatically” may refer to, for example, actions that can be performed with little or no human intervention.

As used herein, devices, including those associated with the system 100 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The extraction platform 150 may store information into and/or retrieve information from the document database 160. The document database 160 may be locally stored or reside remote from the extraction platform 150. Although a single extraction platform 150 is shown in FIG. 1, any number of such devices may be included. Moreover, various devices described herein might be combined according to embodiments of the present invention. For example, in some embodiments, the extraction platform 150 and document database 160 might comprise a single apparatus.

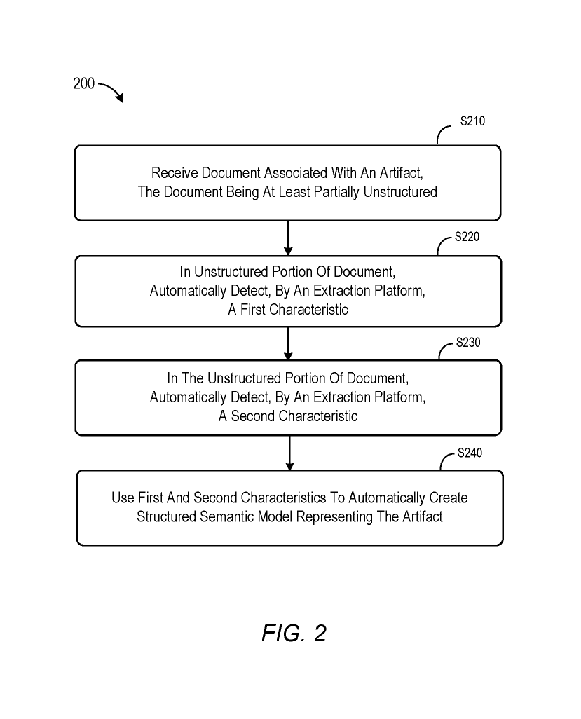

The system 100 may extract the semantic model 170 from the documents 110 in accordance with any of the embodiments described herein. For example, FIG. 2 illustrates a method 200 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a document associated with an artifact may be received, and the document may be at least partially unstructured (e.g., the document may be completely unstructured or partially structured). The artifact might be associated with, for example, any physical apparatus, organization, business, financial arrangement, government, and/or regulatory system.

At S220, an extraction platform may automatically detect a first characteristic in an unstructured portion of the document. Similarly, at S230, the extraction platform may automatically detect a second characteristic in the unstructured portion of the document. As used herein, the term “characteristic” may comprise, for example, a feature of the unstructured portion of the document that was not authored with an intention to explicitly define an item or relationship between items for the artifact. According to some embodiments, the characteristic may be associated with a table, such as a table heading or a table column. As other examples, the characteristic might be associated with a table of contents, a chapter, a section, and/or a page number. Still other examples of characteristic that might be detected include a font size, a font attribute, a font type, an indentation, and a margin (left and/or right margin. According to some embodiments, the document includes text and images and the characteristic is associated with a location of images within the document.

At S240, the first and second characteristics may be used to automatically create a structured semantic model representing the artifact. The structured semantic model may include, for example: systems and subsystems; classes and subclasses; sets and subsets; and/or components and subcomponents.

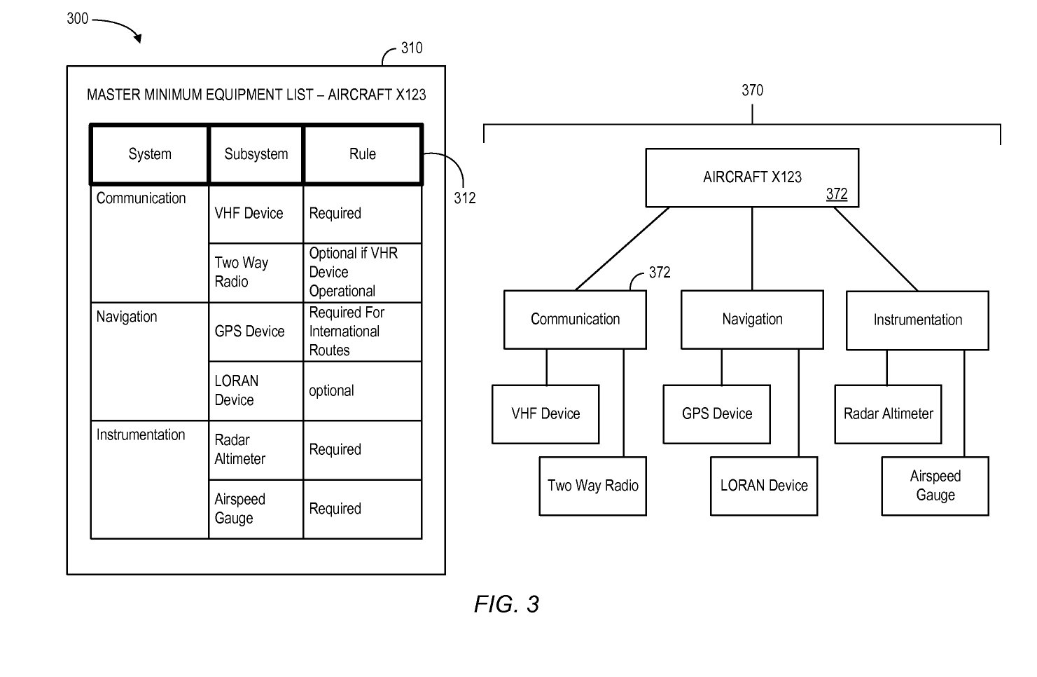

By way of example, FIG. 3 illustrates 300 a document 310 and associated structured semantic model 370 according to some embodiments. The example might comprise, for example, a semantic model of a selected aircraft system with two levels of components from a US Federal Aviation Administration (“FAA”) Master Minimum Equipment (“MMEL”) document. Note that an actual MMEL document may have three or more levels of components. The document 310 includes a table 312 including table headers and columns that may be detected and used to create and organize components 372 for the semantic model 370. For example, the table 312 includes table headers “System” and “Subsystem” that may be detected and used to determine that the “Communication” system includes “VHF Device” and “Two Way Radio” components. The table 312 may further include flight rules (as indicated by the “Rule” table heading) that may be mapped to various components 372 as appropriate. In this way, an understanding of the real-world physical structure of the “X123” aircraft may be gained from studying the semantic model 370.

Thus, some embodiments may recognize and exploit patterns, outside of the explicit meaning of sentences and phrases, which may exist within a document that is normally thought of as unstructured or semi-structured text. When these patterns parallel the structure of an artifact that is the topic of the document, they may be used to create an appropriately structured semantic model of the artifact and/or to align other knowledge extracted from the document with the various components of the artifact.

Note that a semantic model capturing the structure of an artifact (such as a complex piece of equipment) is not usually explicit in documents that describe the operation or other knowledge about the artifact. The structural model may, however, partially manifest itself in various ways. For example, one way is in the structure of the document itself For example, even documents that we normally refer to as unstructured text often have a hierarchical section heading structure. Such a sectioning hierarchy may parallel the structure of the artifact. In other cases, semi-structured text may use indentation levels or a table structure to make the document easier for humans to understand or use as a reference. When that indexing aligns with the hierarchical structure of the artifact, that artifact structure may be implicitly captured from the document.

Some embodiments described herein may recognize and exploit any such parallelism between recognizable patterns in the document and the structure of the artifact, and use these patterns to guide the construction of a semantic model for the artifact. In some cases, such a pattern may be regular and will reflect a fixed number of levels of artifact structure (e.g., system, sub-system, and sub-sub-system). The number of levels in the document pattern may be the optimal number needed for a supporting semantic model of artifact structure to provide a foundation for capturing the knowledge of the document. That is, the number of levels may reflect the way that the subject matter expert has encoded the knowledge in his mental model.

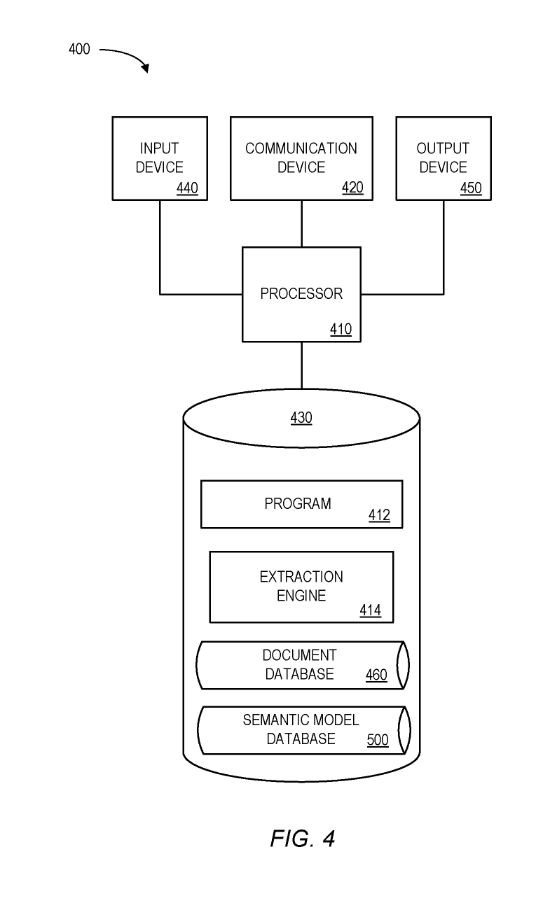

The embodiments described herein may be implemented using any number of different hardware configurations. For example, FIG. 4 is block diagram of an extraction platform 400 that may be, for example, associated with the system 100 of FIG. 1. The extraction platform 400 comprises a processor 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more remote devices (e.g., to receive one or more documents). The extraction platform 400 further includes an input device 440 (e.g., a computer mouse and/or keyboard to input information about documents) and an output device 450 (e.g., a computer monitor to display models and/or generate reports).

The processor 410 also communicates with a storage device 430. The storage device 430 may comprise any appropriate information storage device, including combinations of magnetic storage devices (e.g., a hard disk drive), optical storage devices, mobile telephones, and/or semiconductor memory devices. The storage device 430 stores a program 412 and/or an extraction engine 414 for controlling the processor 410. The processor 410 performs instructions of the programs 412, 414, and thereby operates in accordance with any of the embodiments described herein. For example, the processor 410 may receive a document associated with an artifact, the document being at least partially unstructured. In an unstructured portion of the document, processor 410 may automatically detect a first characteristic. The processor 410 may also automatically detect a second characteristic in the unstructured portion of the document. Using the first and second characteristics, a structured semantic model representing the artifact may automatically be created by processor 410.

The programs 412, 414 may be stored in a compressed, uncompiled and/or encrypted format. The programs 412, 414 may furthermore include other program elements, such as an operating system, clipboard application a database management system, and/or device drivers used by the processor 410 to interface with peripheral devices.

As used herein, information may be “received” by or “transmitted” to, for example: (i) the extraction platform 400 from another device; or (ii) a software application or module within the extraction platform 400 from another software application, module, or any other source.

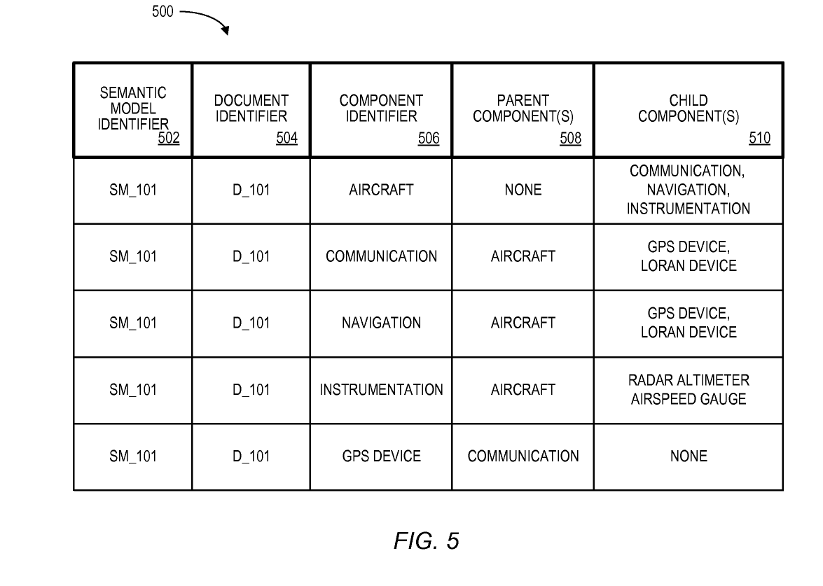

In some embodiments (such as shown in FIG. 4), the storage device 430 stores document database 460 and a semantic model database 500. An example of a database that may be used in connection with the extraction platform 400 will now be described in detail with respect to FIG. 5. Note that the database described herein is only one example, and additional and/or different information may be stored therein. Moreover, various databases might be split or combined in accordance with any of the embodiments described herein.

Referring to FIG. 5, a table is shown that represents the semantic model database 500 that may be stored at the extraction platform 400 according to some embodiments. The table may include, for example, entries identifying structured semantic models that have been create from documents. The table may also define fields 502, 504, 506, 508, 510 for each of the entries. The fields 502, 504, 506, 508, 510 may, according to some embodiments, specify: a semantic model identifier 502, a document identifier 504, a component identifier 506, parent component(s) 508, and child component(s) 510. The semantic model database 500 may be created and updated, for example, when an extraction platform analyzes a document.

The semantic model identifier 502 may be, for example, a unique alphanumeric code identifying an artifact's structured semantic model that has been automatically created from a document associated with the artifact. The document identifier 504 may indicate or point to the document that was used to create the model. The component identifier 506 may describe the component, the parent component(s) 508 may indicate parents of the component, and the child component(s) 510 may indicate any children of the component. In this way, the components may for a hierarchical structure associated with the real world artifact.

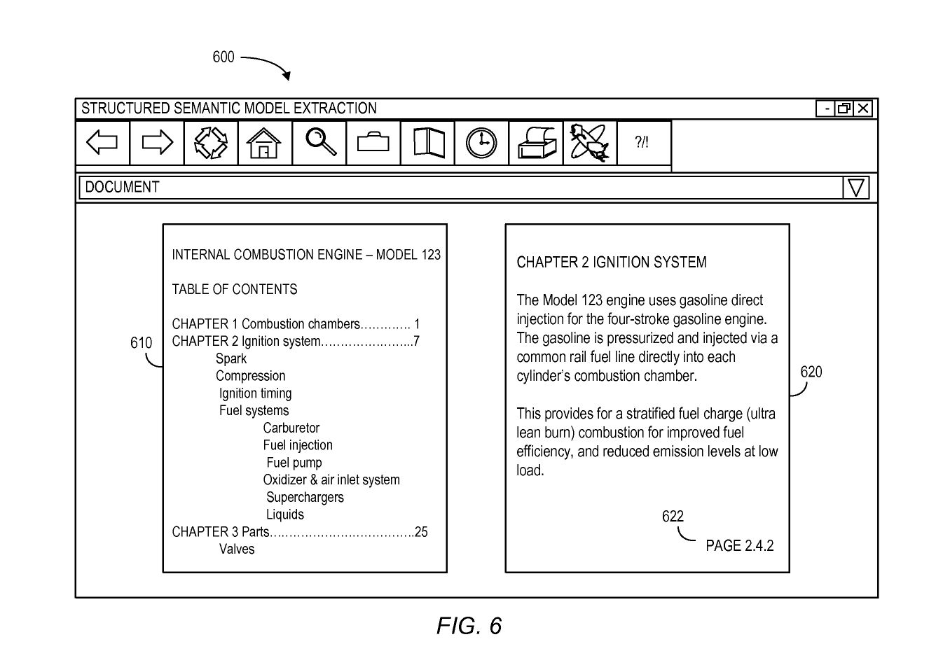

FIG. 6 is an example of a display 600 having table of contents characteristics that might be analyzed in accordance with some embodiments. In particular, a first page 610 of a document includes a table of contents associated with an internal combustion engine that might be used to automatically extract information related to the structure of that engine. For example, chapter or section headings (and associated sub-chapters or sub-sections) might be detected and used to generate a structured semantic model representing the physical layout of the engine's components. Likewise, a second page 620 may include a page number (“Page 2.4.2”) that might be detected and used to create relationships between information on that particular page with information on other pages in the document.

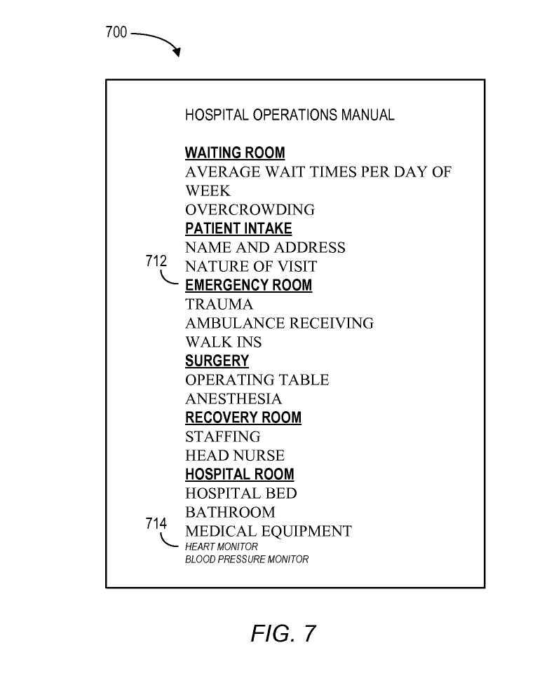

Note that other types of document characteristics may be analyzed and used to create a structured sematic model. For example, FIG. 7 is an example of a document 700 associated with a hospital operations manual and having font characteristics that might be received and analyzed in accordance with some embodiments. For example, an extraction platform might look for bold and/or underlined text 712 in the document 700 and use that information to form a structured semantic model. In the example of FIG. 7, the bold and underlined text 712 representing “Emergency Room” might be detected, and the extraction platform might realize that the “Trauma,” “Ambulance Receiving,” and “Walk Ins” items in the document 700 are subcomponents of the “Emergency Room” component. Note that any kind of font attribute (e.g., italics) might be detected by the extraction engine as well as the font type itself (e.g., Times New Roman as opposed to Arial). As another example, the presence of a smaller point font 712 might indicate, for example, that the associated text (“Heart Monitor” and “Blood Pressure Monitor”) represents components that are sub-subcomponents of “Medical Equipment” for the hospital operations structured semantic model.

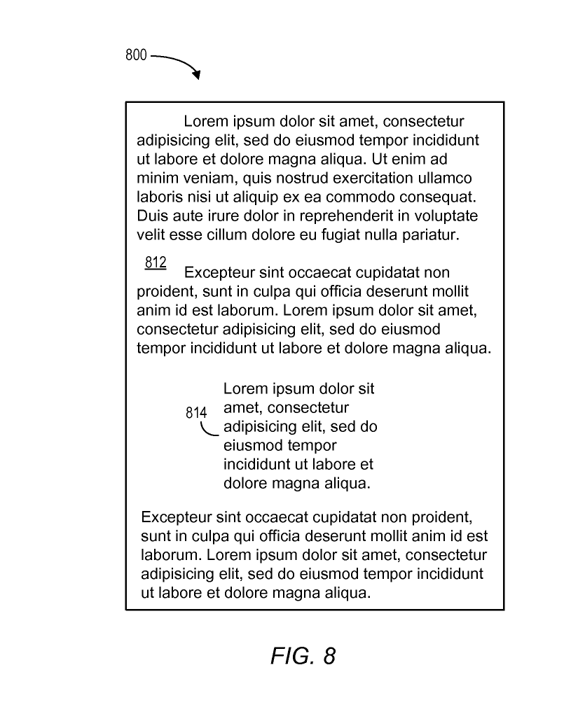

As still another example, FIG. 8 is an example of a document 800 having text layout characteristics that might be received in accordance with some embodiments. In this example, spacing between text line in the document, bullet points, indentations, and/or tabs 812 may be detected and used to associate text in the document 800 with components or sub-components of a structured semantic model. Similarly, changes to the margins 814 (e.g., an increase in the left and/or right margins) of the text in the document 800 may be detected and used to associate text in the document 800 with components or sub-components of a structured semantic model as appropriate (and, in some cases, relationships between components).

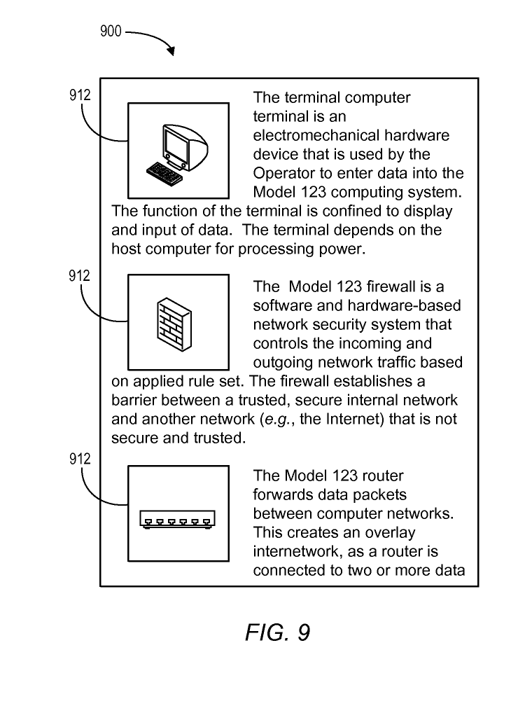

As yet another example, FIG. 9 is an example of a document 900 having image characteristics that might be received in accordance with some embodiments. In this example, the document 900 includes text and images 912 and the detected characteristic is associated with a location of the images 912 within the document 900. For example, each component of a real world artifact associated with the document 900 (the “Model 123 Computing System”) may be separately described in the document beginning with a picture of that component. In this way, the structured sematic model may be built recognizing the main components of the artifact based on the arrangement of the images 912.

Thus, some embodiments described here may provide systems and methods to create a structured semantic model in an automatic and accurate manner. Moreover, the knowledge of a subject matter expert who authored a document (e.g., representing the layout of a complex apparatus) may be captured and used to create the model even when that that knowledge is not explicitly defined within a document.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). Moreover, although some document characteristics have been provide herein as examples, any other type of document characteristic might be detected and used to create a structured sematic model for an artifact.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method, comprising:
receiving a document associated with an artifact, the document being at least partially unstructured;
in an unstructured portion of the document, automatically detecting by an extraction platform a first characteristic;
in the unstructured portion of the document, automatically detecting by an extraction platform a second characteristic; and
using the first and second characteristics to automatically create a structured semantic model representing the artifact.

2. The method of claim 1, wherein the artifact is associated with at least one of: (i) a physical apparatus, (ii) an organization, (iii) a business, (iv) a financial arrangement, (v) a government, (vi) a regulatory system.

3. The method of claim 1, wherein the characteristic is associated with a table.

4. The method of claim 3, wherein the characteristic is associated with at least one of: (i) a table heading, and (ii) a table column.

5. The method of claim 1, wherein the characteristic is associated with at least one of: (i) a table of contents, (ii) a chapter, (iii) a section, and (iv) a page number.

6. The method of claim 1, wherein the characteristic is associated with at least one of: (i) a font size, (ii) a font attribute, and (iii) a font type.

7. The method of claim 1, wherein the characteristic is associated with at least one of: (i) an indentation, (ii) a left margin, and (iii) a right margin.

8. The method of claim 1, wherein the document includes text and images and the characteristic is associated with a location of images within the document.

9. The method of claim 1, wherein the structured semantic model includes at least one of: (i) systems and subsystems, (ii) classes and subclasses, (iii) sets and subsets, and (iv) components and subcomponents.

10. A non-transitory, computer-readable medium storing instructions that, when executed by a computer processor, cause the computer processor to perform a method, the method comprising:
receiving a document associated with a physical device, the document being at least partially unstructured;
in an unstructured portion of the document, automatically detecting by an extraction platform a first characteristic;
in the unstructured portion of the document, automatically detecting by an extraction platform a second characteristic; and
using the first and second characteristics to automatically create a structured semantic model representing the physical object.

11. The medium of claim 10, wherein the characteristic is associated with a table, and the characteristic is associated with at least one of: (i) a table heading, and (ii) a table column.

12. The medium of claim 10, wherein the characteristic is associated with at least one of: (i) a table of contents, (ii) a chapter, (iii) a section, and (iv) a page number.

13. The medium of claim 10, wherein the characteristic is associated with at least one of: (i) a font size, (ii) a font attribute, (iii) a font type, (iv) an indentation, (v) a left margin, and (vi) a right margin.

14. The medium of claim 10, wherein the document includes text and images and the characteristic is associated with a location of images within the document.

15. The medium of claim 10, wherein the structured semantic model includes at least one of: (i) systems and subsystems, (ii) classes and subclasses, (iii) sets and subsets, and (iv) components and subcomponents.

16. An extraction platform, comprising:
a communication port to receive a document associated with an artifact, the document being at least partially unstructured; and
an extraction engine coupled to the communication port and configured to: (i) in an unstructured portion of the document, automatically detect a first characteristic, (ii) in the unstructured portion of the document, automatically detect a second characteristic, and (iii) use the first and second characteristics to automatically create a structured semantic model representing the artifact.

17. The extraction platform of claim 16, wherein the characteristic is associated with a table, and the characteristic is associated with at least one of: (i) a table heading, and (ii) a table column.

18. The extraction platform of claim 16, wherein the characteristic is associated with at least one of: (i) a table of contents, (ii) a chapter, (iii) a section, and (iv) a page number.

19. The extraction platform of claim 16, wherein the characteristic is associated with at least one of: (i) a font size, (ii) a font attribute, (iii) a font type, (iv) an indentation, (v) a left margin, and (vi) a right margin.

20. The extraction platform of claim 16, wherein the document includes text and images and the characteristic is associated with a location of images within the document.

21. The extraction platform of claim 16, wherein the structured semantic model includes at least one of: (i) systems and subsystems, (ii) classes and subclasses, (iii) sets and subsets, and (iv) components and subcomponents.
